(19) United States
(12) Patent Application Publication
(10) Pub. No.: US 2025/0055118 A1
(43) Pub. Date: Feb. 13, 2025

(54) BATTERY PACK

(71) Applicant: TOYOTA JIDOSHA KABUSHIKI KAISHA, Toyota-shi (JP)

(72) Inventor: Hazuki NIWA, Toyota-shi (JP)

(21) Appl. No.: 18/779,244

(22) Filed: Jul. 22, 2024

(30) Foreign Application Priority Data
Aug. 7, 2023 (JP) 2023-128622

(51) Int. Cl. H01M 50/325; H01M 50/186

(52) U.S. Cl. CPC H01M 50/325; H01M 50/186

(57) ABSTRACT

The battery pack comprises: a plurality of batteries; a case having a case body, and a flange portion; and a sealing member; wherein the case comprises: a lower case having an opening formed at an upper end portion; and an upper case covering the opening; wherein the lower case includes a concave lower case body constituting the case body, and a lower flange constituting the flange portion, wherein the upper case includes an upper case body constituting the case body, and an upper flange constituting the flange portion, wherein the lower flange and the upper flange, respectively, include: an end portion in which the sealing member is disposed; and an opposing portion connecting the end portion and the case body, the opposing portion overhanging outwardly from the upper portion, wherein the end portion is inclined with respect to the opposing portion.

### CROSS REFERENCE TO RELATED APPLICATIONS

The present application claims priority from Japanese patent application No. 2023-128622 filed on Aug. 7, 2023, the disclosure of which is hereby incorporated in its entirety by reference into the present application.

### BACKGROUND

### Field

The present disclosure relates to a battery pack.

### Related Art

Conventionally, a battery pack is known to be mounted on a vehicle or the like. For example, JP 2022-165836 A discloses a battery pack having a secondary battery, an upper flange, a lower flange, and a sealing member. The secondary battery is housed in the battery pack. The upper flange is provided in the upper case. The lower flange is provided on the lower case. The sealing member is disposed between the upper flange and the lower flange.

In the battery pack, a large amount of gas containing hydrogen is generated from the secondary battery, and when the pressure in the battery pack becomes high, the upper case may be deformed so as to bulge upward by the pressure in the battery pack. In this case, a part of the upper case body is displaced inwardly. This may cause interference between the upper case and the internal components of the battery pack. Part of the upper case body constitutes a housing chamber for accommodating the battery pack.

### SUMMARY

The present disclosure is feasible in the following aspects.

According to one aspect of the present disclosure, a battery pack is provided. The battery pack comprises: a plurality of batteries; a case having a case body for partitioning a housing chamber for accommodating the plurality of batteries, and a flange portion overhanging outwardly from an upper portion of the case body; and a sealing member for sealing the flange portion; wherein the case comprises: a lower case having an opening formed at an upper end portion; and an upper case covering the opening; wherein the lower case includes a concave lower case body constituting the case body, and a lower flange constituting the flange portion, wherein the upper case includes an upper case body constituting the case body, and an upper flange constituting the flange portion, wherein the lower flange and the upper flange, respectively, include: an end portion in which the sealing member is disposed; and an opposing portion connecting the end portion and the case body, the opposing portion overhanging outwardly from the upper portion, wherein the end portion is inclined with respect to the opposing portion.

According to this aspect, since the flange portion has the opposing portion which overhangs outwardly from the case body, by the pressure in the battery pack is increased, even when the upper case is deformed so as to bulge upward, the upper case body can be suppressed from being deformed inwardly of the housing chamber. Thus, the possibility of interference between the upper case and the pack internal component can be reduced.

### BRIEF DESCRIPTION OF THE DRAWINGS

FIG. 1 is a view of the battery pack from above;

FIG. 2 is a diagram schematically showing II-II cross section of the battery-pack:

FIG. 3 is an explanatory view showing the deformation of the upper case when the internal pressure rises in the conventional battery pack;

FIG. 4 is an explanatory view showing the deformation of the upper case when the internal pressure increases in the first embodiment.

### DETAILED DESCRIPTION

### A. First Embodiment

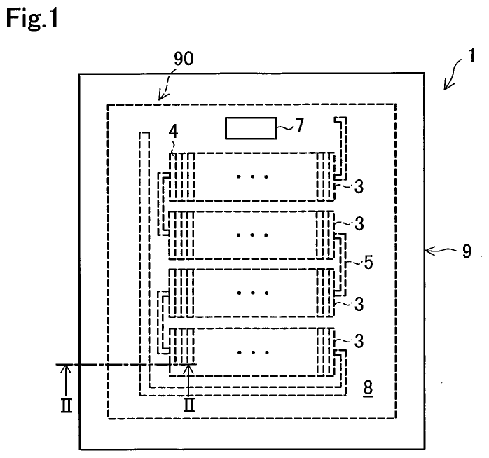

FIG. 1 is a view of the battery pack 1 from the upper direction side. The battery pack 1 includes a case 9, a plurality of modules 3 arranged in the case 9, and a bus bar 5 electrically connecting the plurality of modules 3. The case 9 has a case body 90. The case body 90 partitions the housing chamber 8 for accommodating a plurality of modules 3. Each of the plurality of modules 3 has a plurality of secondary batteries 4. The secondary battery 4 is, for example, a lithium ion battery. The bus bar 5 is a pack internal component, also a high voltage component. The battery pack 1 further includes a pressure release valve 7 formed in the case body 90. The secondary battery 4 is not limited to a lithium ion battery, it may be another battery such as a nickel-metal hydride battery. The pressure release valve 7 is provided at any position of the upper case body 210 having the case body 90 to be described later.

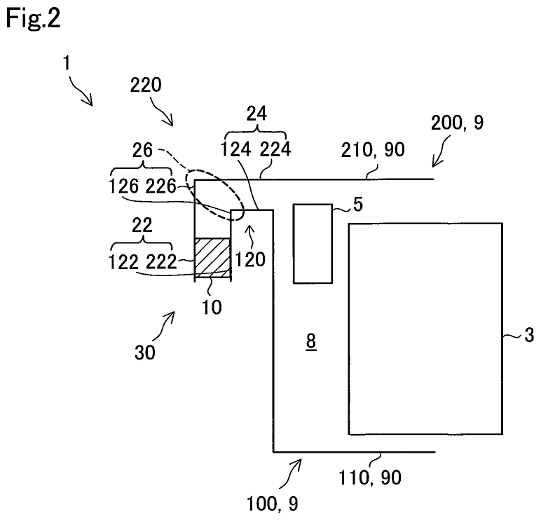

FIG. 2 is a diagram schematically showing II-II cross-section of the battery pack 1 in FIG. 1. Case 9, in addition to the case body 90 has a flange portion 30 which overhangs outwardly from the upper portion of the case body 90. Case 9 has a lower case 100, an upper case 200. Lower case 100 and the upper case 200 is constituted by a metal.

The lower case 100 has an opening at the upper end portion is formed. The lower case 100 has a concave lower case body 110 constituting the case body 90, and a lower flange 120 constituting the flange portion 30. The lower flange 120 protrudes outwardly from the lower case body 110. In the present embodiment, the module 3 is fixed to the lower case body 110 using a bracket and an adhesive (not shown).

The upper case 200 has a shape to cover the opening of the lower case 100. The upper case 200 has an upper case body 210 constituting the case body 90, and an upper flange 220 constituting the flange portion 30. The upper flange 220 overhangs outwardly from the upper case body 210 faces the lower flange 120.

The battery pack 1 further includes a sealing member 10 for sealing the flange portion 30. The sealing member 10 seals between the lower case 100 and the upper case 200 to seal the battery pack 1. More particularly, the sealing member 10 seals between the lower flange 120 and the upper flange 220. The sealing member 10 is, for example, a gasket. Note that the seal member 10 is not limited to a gasket, and may be an adhesive or the like.

The flange portion 30 includes an end portion 22, an opposing portion 24, and a boundary portion 26. The end portion 22 sealing member 10 is disposed. The opposing portion 24 connects the end portion 22 and the case body 90, projecting outwardly from the upper portion of the case body 90. The boundary portion 26 is a boundary between the end portion 22 and the opposing portion 24. The boundary portion 26 is a region where the flange portion 30 is bent.

The lower flange 120 includes a lower flange end 122, a lower flange opposing portion 124, and a lower flange boundary portion 126. The lower flange end 122 constitutes the end 22. The lower flange opposing portion 124 constitutes the opposing portion 24. The lower flange boundary portion 126 constitutes the boundary portion 26.

The upper flange 220 comprises an upper flange end 222, an upper flange opposing portion 224, and an upper flange boundary portion 226. The upper flange portion 222 constitutes an end portion 22. The upper flange opposing portion 224 constitutes the opposing portion 24. The upper flange boundary portion 226 constitutes the boundary portion 26.

The lower flange end 122 and the upper flange end 222 have a shape parallel to each other. The lower flange opposing portion 124 and the upper flange opposing portion 224 also has a parallel shape to each other.

In the present embodiment, the opposing portion 24, the bottom of the lower case body 110, and the upper case body 210 extends in a direction opposing. The direction opposing is a direction perpendicular to the vertical direction of the battery pack 1. The vertical direction is the horizontal direction in the state where the battery pack 1 is arranged in a horizontal plane. Further, the end portion 22 extends from the opposing portion 24 closer to a side where a bottom portion of the lower case body 110 is located. The flange portion 30 is bent at a right angle at the boundary portion 26. The end 22 is inclined at a right angle to the opposing portion 24. Here, the “right angle” corresponds to a case in the range of 90±10°.

In the present embodiment, the bus bar 5 is located between the side surface of the case body 90 (in particular, the side surface of the lower case body 110) and the module 3. In the present embodiment, in the height direction of the battery pack 1, a part of the bus bar 5 is at a height position overlapping with the upper portion of the module 3. Further, the bus bar 5 is arranged at intervals by a predetermined distance from the bottom of the lower case body 110.

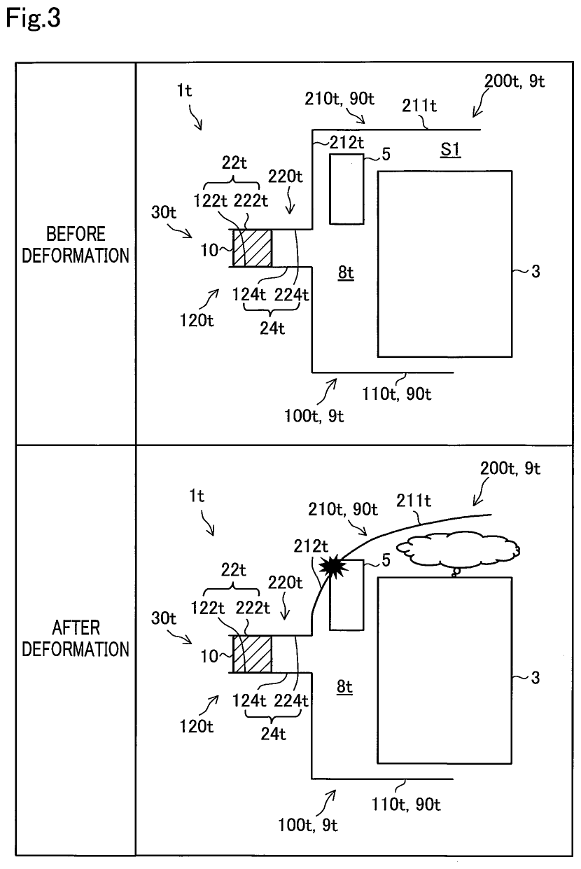

FIG. 3 is an explanatory view illustrating the deformation of the upper case 200t when the internal pressure is increased in a conventional battery pack 1t. The conventional flanged portion 30t in the battery pack 1t is not positioned in the upper portion of the case body 90t, and is positioned in the intermediate portion of the case body 90t.

The flanged portion 30t is made of the end portion 22t and the opposing portion 24t, it has no boundary portion 26. The lower flange 120t includes a lower flange end 122t constituting the end 22t, and a lower flange opposing portion 124t constituting the opposing portion 24t. The upper flange 220t includes an upper flange end 222t constituting the end 22t and an upper flange opposing portion 224t constituting the opposing portion 24t. Further, the upper case body 210t includes a top 211t and the side 212t. Other configurations are the same as in FIG. 2.

In FIG. 3, for example, when the secondary battery 4 constituting the module 3 is short-circuited, there is a case where a large amount of gases containing hydrogen inside the battery pack 1t is generated in a short time. When a large amount of gas containing hydrogen is generated in a short time, even if the battery pack 1t is provided with a pressure release valve 7, there is a possibility that hydrogen gas or the like exceeding the release capability of the pressure release valve 7 is accumulated in the battery pack 1t. In FIG. 3, since the hydrogen-containing gas is lighter than the air, it accumulates in the upper space S1 in the housing chamber 8t. Thus, the top 211t of the upper case body 210t is deformed upward when the internal pressure of the battery-pack 1t exceeds the specified value. On the other hand, the side 212t in the upper case body 210t is deformed toward the busbar 5 under the effect of deformation of the top 211t. Thus, the upper case 200t and the bus bar 5 interferes, a short circuit may occur.

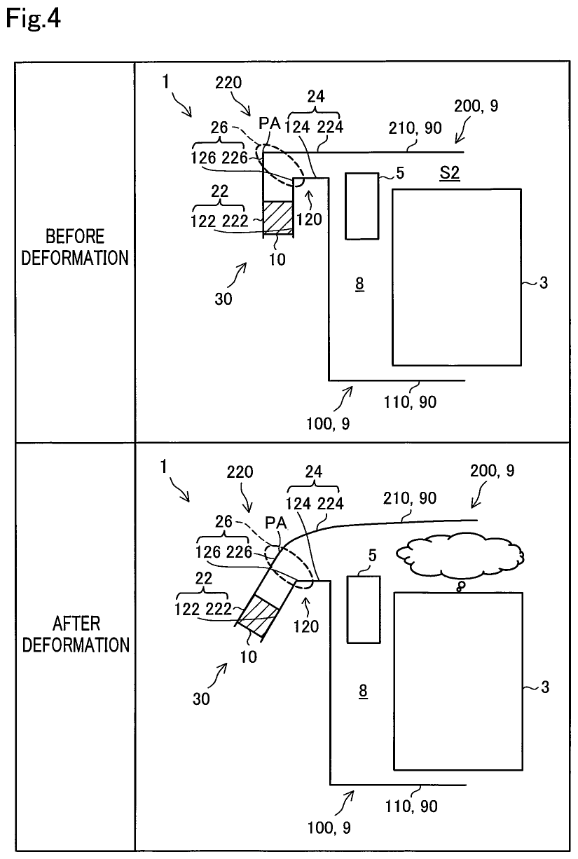

FIG. 4 is an explanatory view showing the deformation of the upper case 200 when the internal pressure increases in the present embodiment. The configuration of a part and the flange portion 30 of the case body 90 in FIG. 4 is similar to that of FIG. 2. Incidentally, of the upper flange boundary portion 226 constituting the boundary portion 26, the bending point PA.

In FIG. 4, for example, when the secondary battery 4 constituting the module 3 is short-circuited, a large amount of gas containing hydrogen inside the battery pack 1 is generated in a short time. Thus, hydrogen gas or the like exceeding the release capability of the pressure release valve 7 is accumulated in the upper space S2 of the housing chamber 8. If the internal pressure of the battery pack 1 by the generation of gas exceeds a specified value, the upper case body 210 is deformed upward. At this time, the upper case 200 is deformed upward from the bending point PA as a starting point. The bending point PA is, of the upper flange 220 located outside of the upper case body 210, a bending point PA of the upper flange boundary portion 226 constituting the boundary portion 26. Thus, since the upper case body 210 is suppressed from being deformed inwardly of the housing chamber 8, the upper case 200 and the bus bar 5 is reduced the possibility of interference. Therefore, short-circuit of the upper case 200 and the bus bar 5 is suppressed.

As described above, in the battery pack 1 of the present embodiment, as shown in FIG. 2, the flange portion 30 has the opposing portion 24 projecting outwardly from the upper portion of the case body 90. Therefore, the pressure in the battery pack 1 is increased, even when the upper case 200 is deformed so as to bulge upward, the upper case body 210 can be suppressed from being deformed inwardly of the housing chamber 8. Thus, the upper case 200 and the bus bar 5 can reduce the possibility of interference. Therefore, it is possible to suppress a short circuit of the upper case 200 and the bus bar 5.

Further, in the battery pack 1 of the present embodiment, the opposing portion 24 and the end portion 22 by the flange portion 30 is bent at a right angle at the boundary portion 26 has a shape inclined at a right angle. Thus, it is possible to suppress the height of the case 9 increases. Furthermore, the distance from the case body 90 to the end portion 22, that is, it is possible to suppress the dimension in a direction perpendicular to the case body 90 is increased. Therefore, it is possible to design a more compact battery pack 1.

### B. Other Embodiments

(B1) In the first embodiment described above, the battery pack 1 is provided with a pressure release valve 7. In contrast, the battery pack 1 may not include the pressure release valve 7.

(B2) In the first embodiment described above, the pack internal component is a bus bar 5. In contrast, the pack internal component may not be the bus bar 5.

(B3) In the first embodiment described above, the flange portion 30 is bent at a right angle at the boundary portion 26, the opposing portion 24 and the end portion 22 is inclined at a right angle. In contrast, the flange portion 30 may not be bent at a right angle at the boundary portion 26, the opposing portion 24 and the end portion 22 may not be inclined at a right angle.

The present disclosure is not limited to the embodiments described above and is able to be realized with various configurations without departing from the spirit thereof. For example, technical features in the embodiments corresponding to the technical features in the aspects described in the section of SUMMARY are able to be replaced with each other or combined together as necessary in order to solve part or the whole of the problems described previously or to achieve part or the whole of the effects described previously. When the technical features are not described as essential features in the present specification, they are able to be deleted as necessary. For example, the present disclosure may be realized by aspects described below.

(1) According to one aspect of the present disclosure, a battery pack is provided. The battery pack comprises: a plurality of batteries; a case having a case body for partitioning a housing chamber for accommodating the plurality of batteries, and a flange portion overhanging outwardly from an upper portion of the case body; and a sealing member for sealing the flange portion; wherein the case comprises: a lower case having an opening formed at an upper end portion; and an upper case covering the opening; wherein the lower case includes a concave lower case body constituting the case body, and a lower flange constituting the flange portion, wherein the upper case includes an upper case body constituting the case body, and an upper flange constituting the flange portion, wherein the lower flange and the upper flange, respectively, include: an end portion in which the sealing member is disposed; and an opposing portion connecting the end portion and the case body, the opposing portion overhanging outwardly from the upper portion, wherein the end portion is inclined with respect to the opposing portion.

According to this aspect, since the flange portion has the opposing portion which overhangs outwardly from the case body, by the pressure in the battery pack is increased, even when the upper case is deformed so as to bulge upward, the upper case body can be suppressed from being deformed inwardly of the housing chamber. Thus, the possibility of interference between the upper case and the pack internal component can be reduced.

(2) In the above aspect, the battery pack may comprise a boundary portion being a boundary between the end portion and the opposing portion, wherein the end portion may be inclined with respect to the opposing portion by bending at the boundary portion.

According to this aspect, the pressure in the battery pack is increased, when the upper case is deformed so as to bulge upward, the upper case is deformed upward starting from the boundary portion. Therefore, it is possible to suppress the possibility of interference between the upper case and the pack internal component.

(3) In the above aspect, the end portion may be inclined with respect to the opposing portion by extending from the opposing portion closer to a side where a bottom portion of the lower case body is located.

According to this aspect, the end portion is located on a lower side compared to the opposing portion, i.e. located on the side close to the bottom portion of the lower case body. Therefore, it is possible to suppress the height of the case is increased.

(4) In the above aspect, the end portion may be inclined with respect to the opposing portion by bending at a right angle to the opposing portion.

According to this aspect, by the end portion is bent at a right angle to the opposing portion, it is possible to suppress the dimension in the direction perpendicular to the height direction of the case is increased.

The present disclosure can be realized in various forms, and in addition to the above form, it can be realized in the form of a method of manufacturing a battery pack or the like.

What is claimed is:

1. A battery pack comprising:
a plurality of batteries;
a case having a case body for partitioning a housing chamber for accommodating the plurality of batteries, and a flange portion overhanging outwardly from an upper portion of the case body; and
a sealing member for sealing the flange portion;
wherein the case comprises:
a lower case having an opening formed at an upper end portion; and
an upper case covering the opening;
wherein the lower case includes a concave lower case body constituting the case body, and a lower flange constituting the flange portion,
wherein the upper case includes an upper case body constituting the case body, and an upper flange constituting the flange portion,
wherein the lower flange and the upper flange, respectively, include:
an end portion in which the sealing member is disposed; and
an opposing portion connecting the end portion and the case body, the opposing portion overhanging outwardly from the upper portion,
wherein the end portion is inclined with respect to the opposing portion.

2. The battery pack according to claim 1, comprising:
a boundary portion being a boundary between the end portion and the opposing portion,
wherein the end portion is inclined with respect to the opposing portion by bending at the boundary portion.

3. The battery pack according to claim 1, wherein
the end portion is inclined with respect to the opposing portion by extending from the opposing portion closer to a side where a bottom portion of the lower case body is located.

4. The battery pack according to claim 1, wherein
the end portion is inclined with respect to the opposing portion by bending at a right angle to the opposing portion.
